(19) United States
(12) Patent Application Publication
(10) Pub. No.: US 2016/0002452 A1
(43) Pub. Date: Jan. 7, 2016

(54) WIPER BLADE ELEMENT

(71) Applicant: ROBERT BOSCH GMBH, Stuttgart (DE)

(72) Inventors: Reiner Lay, Aachen (DE); Valerie Carlier, Gesves (BE); Nicolaas Gotzen, Kortenberg (BE); Vincent Duval, Bruxelles (BE); Eric Pieters, Simpelveld (NL)

(21) Appl. No.: 14/766,802

(22) PCT Filed: Jan. 15, 2014
(86) PCT No.: PCT/EP2014/050732

§ 371 Date: Aug. 10, 2015

(30) Foreign Application Priority Data
Feb. 8, 2013 (DE) 10 2013 202 108.9

(51) Int. Cl. C08L 23/16; B60S 1/38

(52) U.S. Cl. CPC C08L 23/16; B60S 1/38; C08L 2205/03; B60S 2001/3829; B60S 2001/3836

(57) ABSTRACT

The invention relates to a wiper blade element (10) for a wiper blade, for example of a motor vehicle. In order to minimize the running noise, said wiper blade element (10) comprises an elastomer material (A) which comprises a polymer blend from at least one ethylene-propylene-diene rubber (EPDM) and/or at least one ethylene-propylene-rubber (EPM) and at least one ethylene-vinyl-acetate copolymer (EVM), said polymer blend containing at least one ethylene-vinyl acetate-copolymer having a vinyl acetate-content in the region of ≧45 wt.-% to ≦85 wt.-%, with respect to the total weight of the ethylene-vinyl acetate-copolymer. The invention also relates to said type of elastomer material (A) and to a wiper blade equipped with said type of wiper blade element (10).

### BACKGROUND OF THE INVENTION

The invention relates to a wiper rubber, especially for a windshield wiper, to an elastomer material for a wiper rubber and to a windshield wiper.

Wiper rubbers on windshield wipers serve to assure good visibility through a windshield in wet conditions.

As well as the wiping quality achievable by a wiper rubber, further properties of interest in the case of wiper rubbers for windshield wipers are those such as running properties, noise, etc. For example, in the case of conventional wiper rubbers, in screen-wiping operation, unpleasant running noise can occur, such as whistling, squeaking, smacking and noises on change of direction, etc.

Publications DE 199 44 274 A1, WO 2009/130081 A1 and DE 10 2009 001 043 A1 describe wiper rubbers for windshield wipers.

### SUMMARY OF THE INVENTION

The present invention provides a wiper rubber, especially for a windshield wiper, for example of a motor vehicle, comprising an elastomer material.

According to the invention, this elastomer material comprises a polymer blend composed of at least one ethylene-propylene-diene rubber (EPDM) and/or at least one ethylene-propylene rubber (EPM) and at least one ethylene-vinyl acetate copolymer (EVM), containing at least one ethylene-vinyl acetate copolymer having a vinyl acetate content within a range from ≧45% by weight to ≦85% by weight, based on the total weight of the ethylene-vinyl acetate copolymer.

A polymer blend may especially be understood to mean a macroscopically homogeneous mixture of two or more different polymers.

A polymer blend comprising at least one ethylene-propylene-diene rubber (EPDM) and/or at least one ethylene-propylene rubber (EPM) and at least one ethylene-vinyl acetate copolymer (EVM) is also referred to hereinafter as ethylene-propylene(-diene) rubber/ethylene-vinyl acetate copolymer polymer blend or EP(D)M-EVM polymer blend.

For example, the polymer blend may comprise two or more (different) ethylene-propylene-diene rubbers and/or two or more (different) ethylene-propylene rubbers, for example having different ethylene contents and/or propylene contents and/or termonomer contents, and/or termonomers, for example selected from the group consisting of ethylidenenorbornene (ENB), vinylnorbornene (VNB), dicyclopentadiene (DCP), 1,4-hexadiene, and mixtures thereof.

Alternatively or additionally, the polymer blend may comprise two or more ethylene-vinyl acetate copolymers, for example having different vinyl acetate contents and/or ethylene contents. If the polymer blend (EP(D)M-EVM polymer blend) comprises ethylene-vinyl acetate copolymers having different vinyl acetate contents, it is especially possible for all ethylene-vinyl acetate copolymers to have vinyl acetate contents within an abovementioned range.

It has been found that, for example, in the case of use of pure or unblended (not blended with other polymers) ethylene-propylene-diene rubber (EPDM) in elastomer materials for production of wiper rubbers, the wiper rubbers produced therefrom may have good wiping quality, but significant running noise, such as whistling, squeaking, smacking and noises on change of direction, etc., can generally also occur in the operation thereof.

Advantageously, however, running noise of this kind can be minimized or even avoided by using an elastomer material based on a polymer blend composed of ethylene-propylene-diene rubber (EPDM) and/or ethylene-propylene rubber (EPM) and ethylene-vinyl acetate copolymer (EVM) having an abovementioned vinyl acetate content. It is thus advantageously possible to provide a wiper rubber which has good wiping quality and good running properties and can additionally produce barely any or no running noise, such as whistling, squeaking, smacking and noises on change of direction, etc.

The basis of the noise-reducing effect is probably that the ethylene-vinyl acetate copolymer introduces a kind of damping into the elastomer material. It has been found that the noise-reducing effect is dependent on the vinyl acetate content of the ethylene-vinyl acetate copolymer. To achieve the noise-reducing effect, it has been found to be advantageous when the ethylenevinyl acetate copolymer has a vinyl acetate content of at least ≧45% by weight, based on the total weight of the ethylene-vinyl acetate copolymer. On the other hand, it has been found that cold flexibility and hence the running properties of the wiper rubber are also dependent on the vinyl acetate content of the ethylene-vinyl acetate copolymer. With regard to cold flexibility and running properties, it has been found to be advantageous when the vinyl acetate content of the ethylene-vinyl acetate copolymer is ≦85% by weight, based on the total weight of the ethylene-vinyl acetate copolymer.

In the context of one embodiment, the polymer blend comprises at least one ethylene-vinyl acetate copolymer having a vinyl acetate content of ≧50% by weight to ≦85% by weight or ≧80% by weight, based on the total weight of the ethylene-vinyl acetate copolymer. More particularly, the polymer blend (EP(D)M-EVM polymer blend) may comprise at least one ethylene-vinyl acetate copolymer having a vinyl acetate content of ≧55% by weight or ≦60% by weight to ≧85% by weight or ≦80% by weight or ≧75% by weight, based on the total weight of the ethylene-vinyl acetate copolymer. Such vinyl acetate contents have been found to be particularly advantageous with regard to the noise-reducing effect and cold flexibility, and hence also the running properties of the wiper rubber.

As well as ethylene-propylene-diene rubber(s) and/or ethylene-propylene rubber(s) and ethylene-vinyl acetate copolymer(s), the polymer blend may in principle additionally also comprise one or more other polymers, for example selected from the group of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof.

However, it is also possible that the polymer blend is formed from ethylene-propylene-diene rubber(s) and/or ethylene-propylene rubber(s) and ethylene-vinyl acetate copolymer(s).

“Formed” in this connection may especially be understood to mean that no other polymers are present, but other substances such as additives and additions may be present.

The polymer blend may consequently in principle be a polymer blend comprising or formed from at least one ethylene-propylene-diene rubber and/or at least one ethylene-propylene rubber and at least one ethylene-vinyl acetate copolymer (EP(D)M-EVM polymer blend), or comprising or formed from at least one ethylene-propylene-diene rubber and at least one ethylene-vinyl acetate copolymer (EPDM-EVM polymer blend), or comprising or formed from at least one ethylene-propylene rubber and at least one ethylene-vinyl acetate copolymer (EPM-EVM polymer blend).

In the context of a further embodiment, the polymer blend is a polymer blend (EPDM-EVM polymer blend) composed of at least one ethylene-propylene-diene rubber (EPDM) and at least one ethylene-vinyl acetate copolymer (EVM). More particularly, the polymer blend may be a polymer blend (EPDM-EVM polymer blend) formed from at least one ethylene-propylene-diene rubber (EPDM) and at least one ethylene-vinyl acetate copolymer (EVM). By means of ethylene-propylene-diene rubber (EPDM), it is advantageously possible to achieve a higher degree of crosslinking. In addition, ethylene-propylene-diene rubber (EPDM) can advantageously be crosslinked both by peroxides and by sulfur and have good processibility.

The polymer blend may, for example, based on the total weight of polymers in the polymer blend, contain from ≧10% by weight to ≦95% by weight, for example from ≧30% by weight to ≦80% by weight, of ethylene-propylene-diene rubber and/or ethylene-propylene rubber (in total), especially ethylene-propylene-diene rubber (in total). Based on the total weight of the polymers in the polymer blend, the polymer blend may contain, for example, from ≧5% by weight to ≦90% by weight, especially from ≧20% by weight to ≦70% by weight, of ethylene-vinyl acetate copolymer (in total). The weight ratio of ethylene-propylene-diene rubber and/or ethylene-propylene rubber (in total), especially of ethylene-propylene-diene rubber (in total), to ethylene-vinyl acetate copolymer (in total), in the polymer blend may, for example, be within a range from 90:10 to 5:95, for example within a range from 70:30 to 20:80.

In the context of a further embodiment, the polymer blend, based on the total weight of the polymers in the polymer blend, contains from ≧30% by weight to ≦60% by weight of ethylene-vinyl acetate copolymer (in total). More particularly, the polymer blend, based on the total weight of polymers in the polymer blend, may contain from ≧35% by weight to ≦55% by weight of ethylene-vinyl acetate copolymer (in total). Such ethylene-vinyl acetate copolymer contents have been found to be particularly advantageous with regard to the noise-reducing effect and dimensional stability, especially the heat resistance, of the wiper rubber.

For example, the polymer blend may, based on the total weight of the polymers in the polymer blend, contain from ≧40% by weight to ≦70% by weight, for example from ≧45% by weight to ≦65% by weight, of ethylene-propylene-diene rubber and/or ethylene-propylene rubber (in total), especially ethylene-propylene-diene rubber (in total).

For example, the weight ratio of ethylene-propylene-diene rubber and/or ethylene-propylene rubber (in total), especially of ethylene-propylene-diene rubber (in total), to ethylene-vinyl acetate copolymer (in total) in the polymer blend may be within a range from 70:30 to 40:60, especially from 65:35 to 45:55. Such weight ratios have been found to be particularly advantageous for assuring good phase interaction, among other ways.

In the context of a further embodiment, the elastomer material further comprises carbon black. For example, the elastomer material may contain ≧20 parts by weight to ≦120 parts by weight of carbon black per 100 parts by weight of the polymer blend. It has been found that a carbon black content of ≧20 parts by weight per 100 parts by weight of polymer blend is advantageous for achieving good abrasion resistance. In order simultaneously to assure good processibility, however, it has been found to be advantageous not to set the carbon black content too high. To a certain degree, processibility can be improved in the case of high amounts of carbon black by addition of an oil, especially of a plasticizer oil which is to be elucidated in detail later. With regard to the noise-reducing effect and the dynamic properties or running properties of the wiper rubber, it has been found to be advantageous to use not more than ≦120 parts by weight of carbon black and, as will be elucidated in detail later, not more than ≦80 parts by weight of (plasticizer) oil per 100 hundred parts by weight of polymer blend.

In the context of a further embodiment, the elastomer material contains ≧25 parts by weight to ≦95 parts by weight of carbon black per 100 parts by weight of the polymer blend. More particularly, the elastomer material may contain ≧30 parts by weight or ≧35 parts by weight to ≦90 parts by weight or ≦85 parts by weight or ≦80 parts by weight or ≦75 parts by weight of carbon black per 100 parts by weight of the polymer blend. Such carbon black contents have been found to be particularly advantageous with regard to abrasion resistance and processibility. In addition, such carbon black contents have also been found to be particularly advantageous with regard to noise minimization.

In the context of a further embodiment, the elastomer material further comprises at least one plasticizer oil. The addition of a plasticizer oil can advantageously improve processibility and running properties, and possibly minimize running noise.

The at least one plasticizer oil may especially be a paraffinic, naphthenic or aromatic oil, for example a mineral oil, a synthetic oil, a natural oil or an oil mixture thereof. For example, the at least one plasticizer oil may be a mineral oil. More particularly, the at least one plasticizer oil may be a paraffinic oil, for example a highly refined paraffinic mineral oil. For example, the at least one plasticizer oil may be a highly refined paraffinic mineral oil cleaned by catalytic hydrogenation. More particularly, the at least one plasticizer oil may be an oil in accordance with EU Directive 2005/69/EC.

In the context of a further embodiment, the elastomer material comprises at least one plasticizer oil having a pour point within a range from ≧−25° C. to ≦+25° C. More particularly, the elastomer material may include at least one plasticizer oil having a pour point within a range from ≧−15° C. or ≧−10° C. or ≧−5° C. or ≧0° C. to ≦+25° C. or ≦+20° C. or ≦+15° C. or ≦+10° C. or ≦+5° C.

The pour point, according to DIN 51597, refers to the temperature of a liquid product at which it still just flows in the course of cooling.

As the case may be, the at least one plasticizer oil having an abovementioned pour point may also have a setting point within a range from ≧−25° C. to ≦+25° C., especially from ≧−15° C. or ≧−10° C. or ≧−5° C. or ≧0° C. to ≦+25° C. or ≦+20° C. or ≦+15° C. or ≦+10° C. or ≦+5° C. However, it is likewise possible that the at least one plasticizer oil having an abovementioned pour point has a setting point somewhat higher than the abovementioned ranges, since the setting point is usually a few degrees higher than the pour point.

The setting point, according to DIN EN 23015 (formerly DIN 51583), refers to the temperature at which a sample has ceased to flow and no movement of the sample is apparent for 10 seconds.

It has been found that plasticizer oils having an abovementioned pour point and optionally setting point as well have a particularly advantageous effect on the minimization of running noise. The reason for this is probably also that the plasticizer oil having such a pour point introduces a kind of damping into the elastomer material. It has been found that the noise-reducing effect is dependent on the pour point. To achieve the noise-reducing effect, it has been found to be advantageous when a plasticizer oil having a pour point, and as the case may be a setting point as well, of at least ≧−25° C., for example ≧−15° C. or ≧−10° C. or ≧−5° C., is used. On the other hand, it has been found that the cold flexibility and hence other running properties of the wiper rubber are also dependent on the pour point of the plasticizer oil. With regard thereto, it has been found to be advantageous when the plasticizer oil has a pour point, and as the case may be a setting point as well, of ≦+25° C., for example ≦+20° C. or ≦+15° C. or ≦+10° C. or ≦+5° C.

In the context of a further embodiment, the elastomer material contains ≧5 parts by weight to ≦80 parts by weight of plasticizer oil per 100 parts by weight of the polymer blend. More particularly, the elastomer material may contain ≧5 parts by weight to ≦80 parts by weight of plasticizer oil having an abovementioned pour point (and as the case may be a setting point as well) per 100 parts by weight of the polymer blend. This has been found to be advantageous with regard to processibility and running properties, especially minimization of running noise.

For example, the elastomer material may contain ≧5 parts by weight to ≦50 parts by weight, especially ≧10 parts by weight to ≦45 parts by weight, of plasticizer oil per 100 parts by weight of the polymer blend.

In the context of a further embodiment, the elastomer material contains ≧5 parts by weight to ≦50 parts by weight, especially ≧10 parts by weight to ≦45 parts by weight, of plasticizer oil having an abovementioned pour point (and as the case may be a setting point as well) per 100 parts by weight of the polymer blend. This has been found to be particularly advantageous, especially with regard to minimization of running noise.

As well as the at least one plasticizer oil having an abovementioned pour point (and as the case may be a setting point as well), the elastomer material may also comprise one or more other plasticizer oils. In this case, the proportion of other plasticizer oils, however, is preferably lower or not more than just as high as the proportion of plasticizer oils having an abovementioned pour point. If other plasticizer oils are provided, it may be advantageous when the elastomer material contains a total of ≧5 parts by weight to ≦80 parts by weight of plasticizer oils, for example of plasticizer oils having an abovementioned pour point (and as the case may be a setting point as well) and other plasticizer oils in total, per 100 parts by weight of the polymer blend.

In the context of a further embodiment, the weight ratio of carbon black to plasticizer oil is within a range from 90:10 to 50:50, especially within a range from 80:20 to 65:35. This has been found to be advantageous with regard to processibility and running properties, especially minimization of running noise. In particular, the weight ratio of carbon black to plasticizer oil having an abovementioned pour point (and as the case may be a setting point as well) may be within a range of 90:10 to 50:50, especially within a range from 80:20 to 65:35. This has been found to be particularly advantageous for achievement of good running properties and little to no running noise.

In addition, the elastomer material may comprise at least one lubricant, especially selected from the group consisting of graphite, polytetrafluoroethylene, molybdenum sulfide and mixtures thereof. For example, the elastomer material (EP(D)M-EVM polymer blend elastomer material) may contain ≧1 part by weight to ≦20 parts by weight, for example ≧2 parts by weight to ≦15 parts by weight, especially ≧3 parts by weight to ≦10 parts by weight, of lubricants per 100 parts by weight of the polymer blend.

In addition, the elastomer material may comprise at least one crosslinking agent. The crosslinking agent may be a sulfur- and/or peroxide-based crosslinking agent. Preferably, the crosslinking agent is a peroxide-based crosslinking agent. In addition, the elastomer material may comprise one or more crosslinking accelerators and/or sulfur and/or sulfur donor(s) and/or peroxide(s), and optionally crosslinking co-agents.

Furthermore, the elastomer material may comprise further additions such as other plasticizers, white fillers, pigments, colorants, antidegradants, activators, for example zinc oxide, magnesium oxide and/or stearic acid, processing aids and/or moisture absorbents, for example calcium oxide.

In the context of a further embodiment, the wiper rubber has a wiper lip, a tilt element and a fastening section. The wiper lip is especially connected to the tilt element and the tilt element to the fastening section. The wiper lip may especially have a wiper lip head and a wiper lip tip. In this case, the wiper lip head in particular may be connected to the tilt element.

The wiper rubber may be formed partly or fully from the elastomer material (EP(D)M-EVM polymer blend elastomer material).

More particularly, the wiper lip may be formed at least partly from the elastomer material (EP(D)M-EVM polymer blend elastomer material). Alternatively or additionally, the tilt element and/or the fastening section may be formed from the elastomer material (EP(D)M-EVM polymer blend elastomer material).

In the context of one embodiment, the complete wiper rubber is formed from the elastomer material (EP(D)M-EVM polymer blend elastomer material).

In the context of another embodiment, the wiper rubber, for example the wiper lip, comprises at least one further, different elastomer material.

The further, different elastomer material may comprise or be formed from, for example, at least one ethylene-propylene-diene rubber and/or at least one ethylene-propylene rubber, for example ethylene-propylene-diene rubber and/or ethylene-propylene rubber (EP(D)M), especially ethylene-propylene-diene rubber, in pure form or unblended form or in a form not blended with other polymers, or may comprise or be formed from a different polymer blend composed of at least one ethylene-propylene-diene rubber and/or at least one ethylene-propylene rubber and at least one polymer, for example selected from the group consisting of ethylene-vinyl acetate copolymer, polynorbornene, trans-polyoctenamer, polyisobutylene, chloroprene rubber, butyl rubber, chlorobutyl rubber, bromobutyl rubber and mixtures thereof.

The further, different elastomer material may further comprise carbon black, plasticizer oils, lubricants, crosslinking agents, crosslinking accelerators and/or sulfur and/or sulfur donor(s) and/or peroxide(s), crosslinking co-agents and further additions such as other plasticizers, white fillers, pigments, colorants, antidegradants, activators, for example zinc oxide, magnesium oxide and/or stearic acid, processing aids and/or moisture absorbents, for example calcium oxide. With regard to specific embodiments of the further elastomer material, reference is hereby made explicitly to the embodiments elucidated in connection with the EP(D)M-EVM polymer blend or elastomer material.

The further, different elastomer material may differ, for example, in terms of the polymer types and/or contents present therein and/or the additives and/or additions and/or the quantitative ratios thereof.

If the further, different elastomer material comprises a different polymer blend, this may differ, for example, in terms of different ethylene-propylene-diene rubbers and/or ethylene-propylene rubbers, for example with different ethylene contents and/or propylene contents and/or termonomer contents and/or termonomers, for example selected from the group consisting of ethylidenenorbornene (ENB), vinylnorbornene (VNB), dicyclopentadiene (DCP), 1,4-hexadiene, and mixtures thereof, and/or in terms of different ethylene-vinyl acetate copolymers, for example with different vinyl acetate contents and/or ethylene contents, and/or in terms of different additional polymers, for example selected from the group consisting of polynorbornene, trans-polyoctenamer, polyisobutylene, chloroprene rubber, butyl rubber, chlorobutyl rubber and bromobutyl rubber.

In the context of a specific configuration, the further, different elastomer material comprises or is formed from at least one ethylene-propylene-diene rubber and/or at least one ethylene-propylene rubber, for example ethylene-propylene-diene rubber and/or ethylene-propylene rubber (EP(D)M), especially ethylene-propylene-diene rubber, in pure form or unblended form or in a form not blended with other polymers.

In the context of another specific configuration, the further, different elastomer material comprises or is formed from a different polymer blend composed of at least one ethylene-propylene-diene rubber (EPDM) and/or at least one ethylene-propylene rubber (EPM) and at least one ethylene-vinyl acetate copolymer (EVM). The at least one ethylene-vinyl acetate copolymer may have a vinyl acetate content either within an abovementioned range or outside an abovementioned range, for example below an abovementioned range.

In the context of another specific configuration, the further, different elastomer material comprises a polymer blend composed of at least one ethylene-propylene-diene rubber (EPDM) and/or at least one ethylene-propylene rubber (EPM) and at least one polymer selected from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof.

A polymer blend comprising at least one ethylene-propylene-diene rubber (EPDM) and/or at least one ethylene-propylene rubber (EPM) and at least one polymer selected from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof is also referred to hereinafter as EP(D)M-NOR/TOR/PIB/CR/IIR/CIIR/BIIR polymer blend or NOR/TOR/PIB/CR/IIR/CIIR/BIIR polymer blend.

Advantageously, it is additionally possible to minimize or even avoid running noise, such as whistling, squeaking, smacking, noises on change of direction, etc., by additionally using an elastomer material based on an EP(D)M-NOR/TOR/PIB/CR/IIR/CIIR/BIIR polymer blend and/or configuring the polymer blend as an EP(D)M-EVM-NOR/TOR/PIB/CR/IIR/CIIR/BIIR polymer blend.

For example, the NOR/TOR/PIB/CR/IIR/CIIR/BIIR polymer blend may comprise two or more (different) ethylene-propylene-diene rubbers and/or two or more (different) ethylene-propylene rubbers, for example having different ethylene contents and/or propylene contents and/or termonomer contents and/or termonomers, for example selected from the group consisting of ethylidenenorbornene (ENB), vinylnorbornene (VNB), dicyclopentadiene (DCP), 1,4-hexadiene, and mixtures thereof.

Alternatively or additionally, the NOR/TOR/PIB/CR/IIR/CIIR/BIIR polymer blend may comprise two or more (different) polymer types selected from the group consisting of polynorbornene, trans-polyoctenamer, polyisobutylene, chloroprene rubber, butyl rubber, chlorobutyl rubber and bromobutyl rubber, and/or optionally two or more different polymers of the same polymer type from the group consisting of polynorbornene, trans-polyoctenamer, polyisobutylene, chloroprene rubber, butyl rubber, chlorobutyl rubber and bromobutyl rubber.

As well as ethylene-propylene-diene rubber(s) and/or ethylene-propylene rubber(s) and the at least one polymer from the aforementioned group, the NOR/TOR/PIB/CR/IIR/CIIR/BIIR polymer blend may in principle further comprise one or more other polymers, for example ethylene-vinyl acetate copolymer(s).

However, it is also possible that the NOR/TOR/PIB/CR/IIR/CIIR/BIIR polymer blend is formed from ethylene-propylene-diene rubber(s) and/or ethylene-propylene rubber(s) and the at least one polymer from the aforementioned group.

The NOR/TOR/PIB/CR/IIR/CIIR/BIIR polymer blend may in principle be a polymer blend comprising or formed from at least one ethylene-propylene-diene rubber and/or at least one ethylene-propylene rubber and at least one polymer selected from the group consisting of polynorbornene, trans-polyoctenamer, polyisobutylene, chloroprene rubber, butyl rubber, chlorobutyl rubber, bromobutyl rubber and mixtures thereof, or comprising or formed from at least one ethylene-propylene-diene rubber and at least one polymer from this group, or comprising or formed from at least one ethylene-propylene rubber and at least one polymer from this group.

More particularly, the NOR/TOR/PIB/CR/IIR/CIIR/BIIR polymer blend may be a polymer blend composed of at least one ethylene-propylene-diene rubber (EPDM) and at least one polymer selected from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof. Optionally, the NOR/TOR/PIB/CR/IIR/CIIR/BIIR polymer blend may be a polymer blend formed from at least one ethylene-propylene-diene rubber (EPDM) and at least one polymer selected from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof. Ethylene-propylene-diene rubber (EPDM) can advantageously achieve a higher degree of crosslinking In addition, ethylene-propylene-diene rubber (EPDM) can advantageously be crosslinked both by means of peroxides and by means of sulfur and have good processibility.

More particularly, the at least one polymer may be selected from the group consisting of polynorbornene (NOR), trans-polyoctenamer (TOR), polyisobutylene (PIB) and mixtures thereof. For example, the at least one polymer may be polynorbornene (NOR) and/or trans-polyoctenamer (TOR) and/or polyisobutylene (PIB). This has been found to be particularly advantageous.

A noise-reducing effect may advantageously already occur with small amounts of the further polymer. However, it has been found that the amount of the further polymer should not be too high, since in that case there is a decrease in the advantageous properties of the ethylene-propylene-diene and/or ethylene-propylene rubber, especially the good wiping quality, and unwanted effects may in some cases even be caused by the further polymer.

In the case of too high a proportion of polynorbornene, trans-polyoctenamer or chloroprene rubber, the elastomer material may become too hard and the modulus of elasticity thereof too high. This can be counteracted to a certain degree by a decrease in the crosslinker content. A further aspect is heat resistance, which may advantageously still be sufficiently good even in the case of a high proportion of trans-polyoctenamer or chloroprene rubber, but can deteriorate with rising polynorbornene content. In the case of too high a chloroprene rubber content, an unpleasant odor may additionally be established.

In the case of too high a proportion of polyisobutylene, butyl rubber, chlorobutyl rubber or bromobutyl rubber, the elastomer material, in contrast, may become too soft and its modulus of elasticity may fall. The basis of this may especially be poor crosslinkability. Heat resistance may nevertheless be sufficiently good. In the case of too high a chlorobutyl or bromobutyl rubber content, an unpleasant odor may additionally be established.

By means of a combination of two or more of these polymers, especially having opposite effects, these effects can advantageously be balanced out to a certain degree.

In order to provide a wiper rubber having acceptable to good wiping quality and running properties and additionally producing barely any or no running noise, such as whistling, squeaking, smacking, noises on change of direction, etc., it has been found to be advantageous when the weight ratio of ethylene-propylene-diene rubber and/or ethylene-propylene rubber (in total), especially ethylene-propylene-diene rubber (in total), to the at least one polymer, especially the total weight of the at least one polymer, is within a range from 40:60 to 95:5 and/or the proportion of the at least one polymer, i.e. in the case of several polymers the total proportion of the polymers blended with ethylene-propylene-diene rubber and/or ethylene-propylene rubber, is at least ≧5% by weight and at most ≦60% by weight, based on the total weight of polymers in the polymer blend. Thus, it is advantageously possible to provide a wiper rubber which has good wiping quality and good running properties and can additionally produce barely any or no running noise, such as whistling, squeaking, smacking, noises on change of direction, etc.

More particularly, in the NOR/TOR/PIB/CR/IIR/CIIR/BIIR polymer blend, the weight ratio of ethylene-propylene-diene rubber and/or ethylene-propylene rubber (in total), especially ethylene-propylene-diene rubber (in total), to the at least one polymer, especially the total weight of the at least one polymer, may be within a range of 45:55 or 50:50 or 55:45 or 60:40 or 70:30 to 95:5 or 90:10 or 85:15 or 80:20. For example, in the NOR/TOR/PIB/CR/IIR/CIIR/BIIR polymer blend, the weight ratio of ethylene-propylene-diene rubber and/or ethylene-propylene rubber (in total), especially ethylene-propylene-diene rubber (in total), to the at least one polymer, especially the total weight of the at least one polymer, may be within a range of 50:50 to 95:5 or 90:10. This has been found to be particularly advantageous.

For example, the NOR/TOR/PIB/CR/IIR/CIIR/BIIR polymer blend, based on the total weight of the polymers in the polymer blend, may contain ≧5% by weight to ≧60% by weight of the at least one polymer (in total). In this case, the NOR/TOR/PIB/CR/IIR/CIIR/BIIR polymer blend, based on the total weight of the polymers in the polymer blend, may contain especially ≧40% by weight to ≦95% by weight of ethylene-propylene-diene rubber and/or ethylene-propylene rubber (in total), especially ethylene-propylene-diene rubber (in total). For example, the NOR/TOR/PIB/CR/IIR/CIIR/BIIR polymer blend, based on the total weight of the polymers in the polymer blend, may contain ≧5% by weight or ≧10% by weight or ≧15% by weight or ≧20% by weight to ≦55% by weight or ≦50% by weight or ≦45% by weight or ≦40% by weight or ≦30% by weight of the at least one polymer (in total). At the same time, the NOR/TOR/PIB/CR/IIR/CIIR/BIIR polymer blend, based on the total weight of the polymers in the polymer blend, may contain ≧45% by weight or ≧50% by weight or ≧55% by weight or ≧60% by weight or ≧70% by weight to ≦95% by weight or ≦90% by weight or ≦85% by weight ≦ or 80% by weight of ethylene-propylene-diene rubber and/or ethylene-propylene rubber (in total), especially ethylene-propylene-diene rubber (in total).

For example, the NOR/TOR/PIB/CR/IIR/CIIR/BIIR polymer blend, based on the total weight of the polymers in the polymer blend, may contain ≧5% by weight or ≧10% by weight to ≦50% by weight of the at least one polymer and ≧50% by weight to ≦95% by weight or ≦90% by weight of ethylene-propylene-diene rubber and/or ethylene-propylene rubber (in total), especially ethylene-propylene-diene rubber (in total). This has been found to be particularly advantageous.

Polynorbornene can be mixed with the ethylene-propylene-diene rubber and/or ethylene-propylene rubber to give the polymer blend either in pure form or in the form of an oily mixture, for example of a so-called polynorbornene/oil masterbatch. More particularly, however, the polynorbornene can be used in the form of a polynorbornene/oil mixture. This has been found to be especially advantageous for the processibility of the polymer blend or elastomer material. The oil in the polynorbornene/oil mixture may especially be a plasticizer oil or plasticizer oil mixture. More particularly, the (plasticizer) oil in the polynorbornene/oil mixture may likewise be a paraffinic, naphthenic or aromatic oil, for example a mineral oil, a synthetic oil, a natural oil or an oil mixture thereof. More particularly, the (plasticizer) oil in the polynorbornene/oil mixture may have a pour point (and as the case may be a setting point as well) within the range from ≧−25° C. to ≦+25° C., especially from ≧−15° C. or ≧−10° C. or ≧−5° C. or ≧0° C. to ≦+25° C. or ≦+20° C. or ≦+15° C. or ≦+10° C. or ≦+5° C. More particularly, the oil in the polynorbornene/oil mixture may be the same oil as the at least one plasticizer oil, especially having an abovementioned pour point. In the polynorbornene/oil mixture, the weight ratio of polynorbornene to the oil may especially be within a range from 30:70 to 70:30. If the oil in the polynorbornene/oil mixture is used in addition to the at least one plasticizer oil, especially having a pour point within a range from ≧−25° C. to ≦+25° C., the elastomer material preferably contains a total of ≧5 parts by weight to ≦80 parts by weight of plasticizer oils per 100 parts by weight of the polymer blend, for example of plasticizer oils having an abovementioned pour point (and as the case may be a setting point as well) and other plasticizer oils in total.

In the case of polyisobutylene, preference is given especially to polyisobutylene having a molecular weight of ≧100 000 g/mol. Such a molecular weight can advantageously improve processibility.

In the context of one configuration, the wiper lip is formed partly or fully from a different elastomer material than the tilt element and optionally the fastening section. More particularly, the wiper lip tip may be formed from a different elastomer material than the tilt element and optionally the fastening section. The wiper lip head may be formed at least partly from the same elastomer material as the tilt element and optionally the fastening section, and at least partly from the same elastomer material as the wiper lip tip.

In the context of one variant of this configuration, the elastomer material of the wiper lip, especially of the wiper lip tip, has been optimized with respect to damping and associated minimization of noise, whereas the elastomer material of the tilt element and optionally of the fastening section and optionally of the wiper lip head may have been optimized with respect to another property, for example cold flexibility and/or heat resistance.

In this case, the elastomer material of the wiper lip, especially of the wiper lip tip, may comprise an ethylene-propylene(-diene) rubber/ethylene-vinyl acetate copolymer polymer blend having an abovementioned vinyl acetate content. The elastomer material of the tilt element and optionally the fastening section and optionally of the wiper lip head may comprise a different ethylene-propylene(-diene) rubber/ethylene-vinyl acetate copolymer polymer blend than the elastomer material of the wiper lip or be an elastomer material based on another polymer, for example on ethylene-propylene-diene rubber and/or ethylene-propylene rubber (EP(D)M), especially ethylene-propylene-diene rubber, in pure form or unblended form or in a form not blended with other polymers, or an EP(D)M-NOR/TOR/PIB/CR/IIR/CIIR/BIIR polymer blend or an EP(D)M-EVM-NOR/TOR/PIB/CR/IIR/CIIR/BIIR polymer blend.

The use of an ethylene-propylene(-diene) rubber/ethylene-vinyl acetate copolymer polymer blend having an abovementioned vinyl acetate content in the wiper lip, especially wiper lip tip, can advantageously achieve damping and associated minimization of noise through the wiper lip, especially wiper lip tip.

If the elastomer material of the tilt element and, as the case may be, of the fastening section and, as the case may be, of the wiper lip head comprises a different ethylene-propylene(-diene) rubber/ethylene-vinyl acetate copolymer polymer blend, this may especially have a smaller vinyl acetate content, which may likewise be either within the abovementioned range or, as the case may be, lower. This can improve cold flexibility and/or heat resistance. By virtue of the tilt element and, as the case may be, the fastening section and, as the case may be, the wiper lip head comprising especially unblended ethylene-propylene(-diene) rubber, it is advantageously likewise possible to improve cold flexibility and/or heat resistance.

In the context of another variant of this configuration, the elastomer material of the tilt element and/or the fastening section and/or the wiper lip head has been optimized with respect to damping and the associated minimization of noise and optionally cold flexibility and/or heat resistance, whereas the elastomer material of the wiper lip, especially the wiper lip tip, may have been optimized with respect to another property, for example friction.

In this case, the elastomer material of the tilt element and, as the case may be, fastening section and, as the case may be, of the wiper lip head may comprise an ethylene-propylene(-diene) rubber/ethylene-vinyl acetate copolymer polymer blend having an abovementioned vinyl acetate content. The elastomer material of the wiper lip, especially the wiper lip tip, may comprise an ethylene-propylene(-diene) rubber/ethylene-vinyl acetate copolymer polymer blend different than the elastomer material of the wiper lip or be an elastomer material based on another polymer, for example on ethylene-propylene-diene rubber and/or ethylene-propylene rubber (EP(D)M), especially ethylene-propylene-diene rubber, in pure form or unblended form or in a form not blended with other polymers, or an EP(D)M-NOR/TOR/PIB/CR/IIR/CIIR/BIIR polymer blend or an EP(D)M-EVM-NOR/TOR/PIB/CR/IIR/CIIR/BIIR polymer blend.

The use of an ethylene-propylene(-diene) rubber/ethylene-vinyl acetate copolymer polymer blend having an abovementioned vinyl acetate content in the tilt element and, as the case may be, the fastening section and, as the case may be, the wiper lip head can advantageously achieve damping and associated minimization of noise through the tilt element and, as the case may be, fastening section and, as the case may be, wiper lip head.

If the elastomer material of the tilt element and, as the case may be, of the fastening section and, as the case may be, of the wiper lip head comprises a different ethylene-propylene(-diene) rubber/ethylene-vinyl acetate copolymer polymer blend than the wiper lip, the ethylene-propylene(-diene) rubber/ethylene-vinyl acetate copolymer polymer blend of the tilt element, as the case may be of the fastening section and as the case may be of the wiper lip head may especially have a higher vinyl acetate content than the ethylene-propylene(-diene) rubber/ethylene-vinyl acetate copolymer polymer blend of the wiper lip, especially wiper lip tip. Thus, damping and hence minimization of noise can be achieved through the tilt section, as the case may be the fastening section and as the case may be the wiper lip head. The elastomer material of the wiper lip, especially of the wiper lip tip, may be an ethylene-propylene(-diene) rubber/ethylene-vinyl acetate copolymer polymer blend having a relatively low vinyl acetate content, which may either be within the abovementioned range or lower, or based on another polymer, for example on ethylene-propylene-diene rubber and/or ethylene-propylene rubber (EP(D)M), especially ethylene-propylene-diene rubber, in pure form or unblended form or in a form not blended with other polymers, or an EP(D)M-NOR/TOR/PIB/CR/IIR/CIIR/BIIR polymer blend or an EP(D)M-EVM-NOR/TOR/PIB/CR/IIR/CIIR/BIIR polymer blend.

With regard to further technical features and advantages of the wiper rubber of the invention, reference is hereby made explicitly to the elucidations in connection with the elastomer material of the invention and the windshield wiper of the invention, and to the figures and the description of figures.

The invention further provides an elastomer material for a wiper blade, especially for a windshield wiper, for example of a motor vehicle, comprising a polymer blend composed of at least one ethylene-propylene-diene rubber and/or at least one ethylene-propylene rubber and at least one ethylene-vinyl acetate copolymer, wherein the polymer blend comprises at least one ethylene-vinyl acetate copolymer having a vinyl acetate content within a range from ≧45% by weight to ≦85% by weight, based on the total weight of the ethylene-vinyl acetate copolymer. More particularly, it is especially possible for all the ethylene-vinyl acetate copolymers in the polymer blend to have vinyl acetate contents within an abovementioned range.

More particularly, the polymer blend (EP(D)M-EVM polymer blend) may comprise at least one ethylene-vinyl acetate copolymer having a vinyl acetate content of ≧50% by weight to ≦85% by weight or ≦80% by weight, based on the total weight of the ethylene-vinyl acetate copolymer. For example, the polymer blend (EP(D)M-EVM polymer blend) may comprise at least one ethylene-vinyl acetate copolymer having a vinyl acetate content of ≧55% by weight or ≧60% by weight to ≦85% by weight or ≦80% by weight or ≦75% by weight, based on the total weight of the ethylene-vinyl acetate copolymer.

In the context of one embodiment, the elastomer material (EP(D)M-EVM polymer blend elastomer material) further comprises carbon black. For example, the elastomer material may contain ≧20 parts by weight to ≦120 parts by weight of carbon black, especially ≧25 parts by weight to ≦95 parts by weight, for example ≧30 parts by weight or ≧35 parts by weight to ≦90 parts by weight or ≦85 parts by weight or ≦80 parts by weight or ≦75 parts by weight, per 100 parts by weight of the polymer blend.

In the context of a further embodiment, the elastomer material (EP(D)M-EVM polymer blend elastomer material) further comprises at least one plasticizer oil. More particularly, the elastomer material may comprise at least one plasticizer oil having a pour point within a range from ≧−25° C. to ≦+25° C., especially from ≧−15° C. or ≧−10° C. or ≧−5° C. or ≧0° C. to ≦+25° C. or ≦+20° C. or ≦+15° C. or ≦+10° C. or ≦+5° C. For example, the elastomer material (EP(D)M-EVM polymer blend elastomer material) may contain ≧5 parts by weight to ≦80 parts by weight, for example ≧5 parts by weight to ≦50 parts by weight, especially ≧10 parts by weight to ≦45 parts by weight, of plasticizer oil having an abovementioned pour point per 100 parts by weight of the polymer blend.

In the context of a further embodiment, the weight ratio of carbon black to the at least one plasticizer oil, especially having a pour point within a range from ≧−25° C. to ≦+25° C., is within a range from 90:10 to 50:50, for example from 80:20 to 65:35.

In addition, the elastomer material (EP(D)M-EVM polymer blend elastomer material) may comprise lubricants, crosslinking agents, crosslinking accelerators, sulfur and/or sulfur donor(s) and/or peroxide(s), crosslinking co-agents, other plasticizers, white fillers, pigments, colorants, antidegradants, activators, for example zinc oxide, magnesium oxide and/or stearic acid, processing aids and/or moisture absorbents, for example calcium oxide.

With regard to further technical features and advantages of the elastomer material of the invention, reference is hereby made explicitly to the elucidations in connection with the wiper rubber of the invention and the windshield wiper of the invention, and to the figures and the description of figures.

The invention further relates to a windshield wiper comprising a wiper rubber of the invention and/or an elastomer material of the invention.

With regard to further technical features and advantages of the windshield wiper of the invention, reference is hereby made explicitly to the elucidations in connection with the wiper rubber of the invention and the elastomer material of the invention, and to the figures and the description of figures.

### BRIEF DESCRIPTION OF THE DRAWINGS

Further advantages and advantageous configurations of the subject matter of the invention are illustrated by the drawings and the working example and elucidated in the description which follows. It should be noted that the drawings and the working example have merely descriptive character and are not intended to restrict the invention in any way at all. The figures show:

FIG. 1 a schematic cross section through a first embodiment of a wiper rubber of the invention;

FIG. 2 a schematic cross section through a second embodiment of a wiper rubber of the invention;

FIG. 3 a schematic cross section through a third embodiment of a wiper rubber of the invention;

FIG. 4 a schematic cross section through a fourth embodiment of a wiper rubber of the invention and

FIG. 5 a schematic cross section through a fifth embodiment of a wiper rubber of the invention.

### DETAILED DESCRIPTION

FIGS. 1 to 5 illustrate that the embodiments of wiper rubbers 10 shown therein each have a wiper lip 11, a tilt element 12 and a fastening section 13. The wiper lip 11 has a wiper lip head 1 la and a wiper lip tip 11b. The wiper lip tip 11b has two wiping edges 11′, 11″ which sweep across the windshield 20 to be wiped during the wiping motion and in so doing push water off the windshield 20. The wiper lip tip 11b is connected to the wiper lip head 11a, which 11a is in turn connected via the tilt element 12 to the fastening section 13, such that the entire wiper lip 11 can be tilted about the tilt element 12 during the wiping motion.

In the embodiments shown in FIGS. 1 to 3, the complete wiper rubber 10 is formed from an elastomer material A comprising a polymer blend composed of at least one ethylene-propylene-diene rubber (EPDM) and/or at least one ethylene-propylene rubber (EPM) and at least one ethylene-vinyl acetate copolymer (EVM) having a vinyl acetate content within a range from ≧45% by weight to ≦85% by weight, based on the total weight of the ethylene-vinyl acetate copolymer.

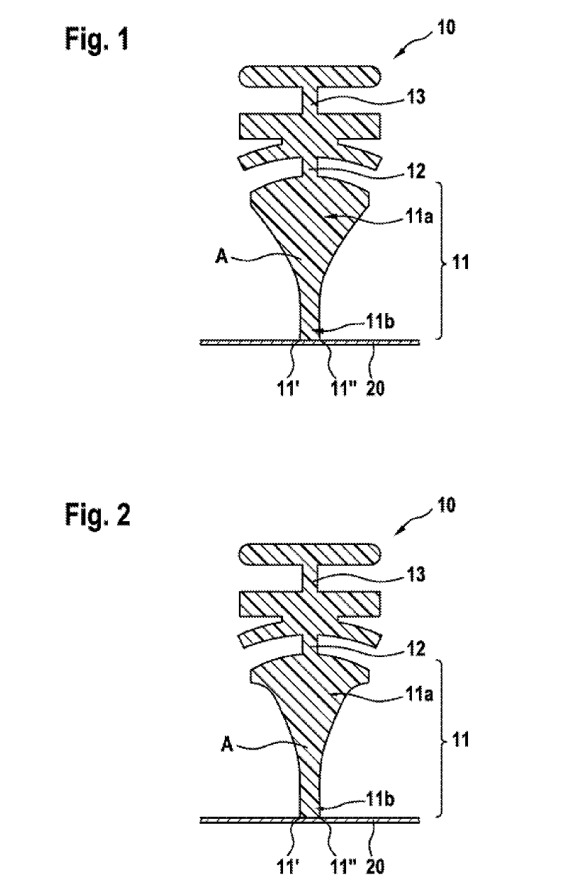

The embodiment shown in FIG. 2 differs from the embodiment shown in FIG. 1 essentially in that the wiper lip head 11a is more significantly narrowed in the direction of the wiper lip tip 11b than in the embodiment shown in FIG. 1.

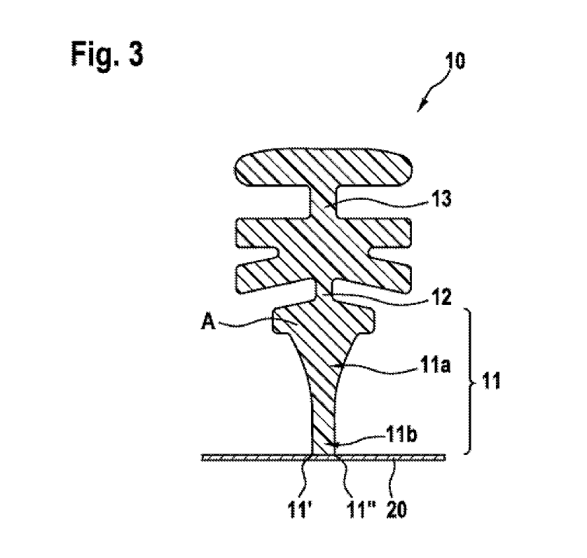

The embodiment shown in FIG. 3 differs from the embodiment shown in FIG. 2 essentially in that the wiper lip head 11a is narrower and the wiper lip 11 is shorter or less high overall than in the embodiment shown in FIG. 2.

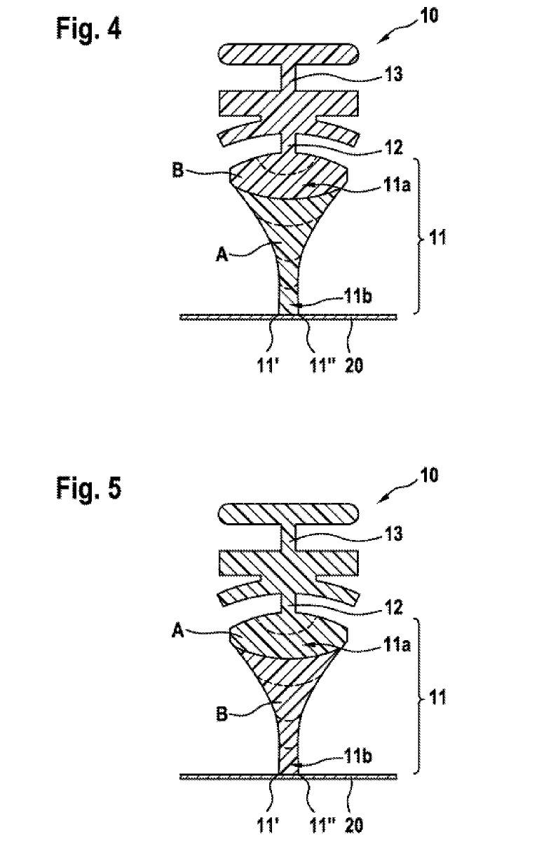

In the embodiments shown in FIGS. 4 and 5, the wiper rubber 10 is formed from two different elastomer materials A, B. In the embodiment shown in FIG. 4, the wiper lip tip 11b is formed from the elastomer material A and the wiper lip head 11a, the tilt element 12 and the fastening section 13 from a further elastomer material B. Conversely, in the embodiment shown in FIG. 5, the wiper lip head 11a, the tilt element 12 and the fastening section 13 are formed from the elastomer material A and the wiper lip tip 11b from the further, different elastomer material B. The dotted lines indicate that the connecting region between the elastomer material A and the elastomer material B may also be closer to the wiper lip tip 11b or closer to the tilt element 12. According to the configuration, it is possible for only a portion of the wiper lip tip 11b to be formed from one elastomer material A, B and the other portion of the wiper lip tip 11b together with the wiper lip head 11a, the tilt element 12 and the fastening section 13 from the further, different elastomer material B, A; or for the wiper lip tip 11b and only a portion of the wiper lip head 11a to be formed from one elastomer material A, B and the other portion of the wiper lip head 11a together with the tilt element 12 and the fastening section 13 from the further, different elastomer material B, A.

In the embodiments shown in FIGS. 4 and 5, the elastomer material A, just like the elastomer material A in the embodiments shown in FIGS. 1 to 3, comprises a polymer blend of at least one ethylene-propylene-diene rubber (EPDM) and/or at least one ethylene-propylene rubber (EPM) and at least one ethylene-vinyl acetate copolymer (EVM) having a vinyl acetate content within a range from ≧45% by weight to ≦85% by weight, based on the total weight of the ethylene-vinyl acetate copolymer. The further elastomer component B may comprise, for example, ethylene-propylene-diene rubber (EPDM) and/or ethylene-propylene rubber (EPM) or an EP(D)M-NOR/TOR/PIB/CR/IIR/CIIR/BIIR polymer blend or an EP(D)M-EVM-NOR/TOR/PIB/CR/IIR/CIIR/BIIR polymer blend or likewise a (different) ethylene-propylene(-diene) rubber/ethylene-vinyl acetate copolymer polymer blend (EP(D)M-EVM polymer blend). If the further elastomer component B likewise comprises an EP(D)M-EVM polymer blend, this may especially include an ethylene-vinyl acetate copolymer having a lower vinyl acetate content than the ethylene-vinyl acetate copolymer of elastomer component A. The vinyl acetate content of elastomer component B may likewise be within a range from ≧45% by weight to ≦85% by weight, based on the total weight of the ethylene-vinyl acetate copolymer, or lower.

### Example

55 parts by weight of ethylene-propylene-diene rubber (EPDM) were mixed with 45 parts by weight of ethylene-vinyl acetate copolymer (EVM) having a vinyl acetate content of 60% by weight, based on the total weight of the ethylene-vinyl acetate copolymer, to give a polymer blend. Subsequently, 60 parts by weight of carbon black and 30 parts by weight of a mineral plasticizer oil according to EU Directive 2005/69/EC having a pour point of −6° C. were added to 100 parts by weight of the polymer blend.

A wiper rubber was produced from the resulting elastomer material, and the running noise, running properties and abrasion resistance thereof were tested in wiping operation.

The wiper rubber produced little to no running noise in wiping operation and had good running properties and good abrasion resistance.

1. A wiper rubber (10), comprising an elastomer material (A) comprising a polymer blend composed of at least one ethylene-propylene-diene rubber and/or at least one ethylene-propylene rubber and at least one ethylene-vinyl acetate copolymer,
wherein the polymer blend contains at least one ethylene-vinyl acetate copolymer having a vinyl acetate content within a range from ≧45% by weight to ≦85% by weight, based on the total weight of the ethylene-vinyl acetate copolymer.

2. The wiper rubber (10) as claimed in claim 1, wherein the polymer blend contains at least one ethylene-vinyl acetate copolymer having a vinyl acetate content within a range from ≧55% by weight to ≦85% by weight, based on the total weight of the ethylene-vinyl acetate copolymer.

3. The wiper rubber (10) as claimed in claim 1, wherein the polymer blend, based on the total weight of polymers in the polymer blend, contains ≧30% by weight to ≦60% by weight of ethylene-vinyl acetate copolymer.

4. The wiper rubber (10) as claimed in claim 1, wherein the polymer blend is a polymer blend composed of at least one ethylene-propylene-diene rubber and at least one ethylene-vinyl acetate copolymer.

5. The wiper rubber (10) as claimed in claim 1, wherein the elastomer material (A) further comprises carbon black.

6. The wiper rubber (10) as claimed in claim 1, wherein the elastomer material (A) further comprises at least one plasticizer oil.

7. The wiper rubber (10) as claimed in claim 1, wherein the elastomer material (A) contains from ≧30 parts by weight to ≦90 parts by weight of carbon black per 100 parts by weight of the polymer blend, and/or wherein the elastomer material (A) contains ≧5 parts by weight to ≦80 parts by weight of the at least one plasticizer oil having a pour point within a range from ≧−25° C. to ≦+25° C. per 100 parts by weight of the polymer blend.

8. The wiper rubber (10) as claimed in claim 1, wherein the wiper blade (10) has a wiper lip (11), a tilt element (12) and a fastening section (13), wherein the wiper lip (11) is connected to the tilt element (12) and the tilt element (12) to the fastening section (13),
wherein the wiper lip (11) is at least partly formed from the elastomer material (A), and/or
wherein the tilt element (12) and/or the fastening section (13) is formed from the elastomer material (A).

9. The wiper rubber (10) as claimed in claim 1, wherein the wiper rubber (10) comprises at least one further, different elastomer material (B), especially one which comprises ethylene-propylene-diene rubber and/or ethylene-propylene rubber or a different polymer blend composed of at least one ethylene-propylene-diene rubber and/or at least one ethylene-propylene rubber and at least one polymer selected from the group consisting of ethylene-vinyl acetate copolymer, polynorbornene, trans-polyoctenamer, polyisobutylene, chloroprene rubber, butyl rubber, chlorobutyl rubber, bromobutyl rubber and mixtures thereof.

10. An elastomer material (A) for a wiper rubber (10), comprising a polymer blend composed of at least one ethylene-propylene-diene rubber and/or at least one ethylene-propylene rubber and at least one ethylene-vinyl acetate copolymer, wherein the polymer blend comprises at least one ethylene-vinyl acetate copolymer having a vinyl acetate content within a range from ≧45% by weight to ≦85% by weight, based on the total weight of the ethylene-vinyl acetate copolymer.

11. The elastomer material (A) as claimed in claim 10, wherein the elastomer material (A) further comprises carbon black, especially wherein the elastomer material contains ≧30 parts by weight to ≦90 parts by weight of carbon black per 100 parts by weight of the polymer blend.

12. The elastomer material (A) as claimed in claim 10, wherein the elastomer material (A) further comprises at least one plasticizer oil, especially having a pour point within a range from ≧−25° C. to ≦+25° C.

13. The elastomer material (A) as claimed in claim 12, wherein the weight ratio of carbon black to the at least one plasticizer oil especially having a pour point within a range from ≧−25° C. to ≦+25° C. is within a range from 90:10 to 50:50.

14. A windshield wiper comprising a wiper rubber (10) as claimed in claim 1.

15. A windshield wiper comprising an elastomer material as claimed in claim 11.

16. The wiper rubber (10) as claimed in claim 1, wherein the elastomer material comprises at least one plasticizer oil having a pour point within a range from ≧−25° C. to ≦+25° C.

17. The wiper rubber (10) as claimed in claim 1,
wherein the elastomer material (A) contains from ≧30 parts by weight to ≦90 parts by weight of carbon black per 100 parts by weight of the polymer blend, and/or
wherein the elastomer material (A) contains ≧5 parts by weight to ≦80 parts by weight of the at least one plasticizer oil having a pour point within a range from ≧−25° C. to ≦+25° C. per 100 parts by weight of the polymer blend,
and wherein the weight ratio of carbon black to the at least one plasticizer oil having a pour point within a range from ≧−25° C. to ≦+25° C. is within a range from 90:10 to 50:50.

18. The wiper rubber (10) as claimed in claim 1, wherein the wiper rubber (10) comprises at least one further, different elastomer material (B) which comprises ethylene-propylene-diene rubber and/or ethylene-propylene rubber or a different polymer blend composed of at least one ethylene-propylene-diene rubber and/or at least one ethylene-propylene rubber and at least one polymer selected from the group consisting of ethylene-vinyl acetate copolymer, polynorbornene, trans-polyoctenamer, polyisobutylene, chloroprene rubber, butyl rubber, chlorobutyl rubber, bromobutyl rubber and mixtures thereof.

19. The elastomer material (A) as claimed in claim 10, wherein the elastomer material contains ≧30 parts by weight to ≦90 parts by weight of carbon black per 100 parts by weight of the polymer blend.

20. The elastomer material (A) as claimed in claim 10, wherein the elastomer material (A) further comprises at least one plasticizer oil having a pour point within a range from ≧−25° C. to ≦+25° C.

21. The elastomer material (A) as claimed in claim 20, wherein the weight ratio of carbon black to the at least one plasticizer oil having a pour point within a range from ≧−25° C. to ≦+25° C. is within a range from 90:10 to 50:50.
